(19) United States
(12) Patent Application Publication
(10) Pub. No.: US 2019/0163235 A1
(43) Pub. Date: May 30, 2019

(54) Mobile Phone and Back Panel Therefor, Transformable into Retractable Selfie Stick

(71) Applicant: STIKBOX TECHNOLOGIES LIMITED, Milton Keynes (GB)

(72) Inventors: David Sherman, Manchester (GB); Yekutiel Sherman, Manchester (GB)

(73) Assignee: STIKBOX TECHNOLOGIES LIMITED, Milton Keynes (GB)

(21) Appl. No.: 16/323,524

(22) PCT Filed: Jul. 31, 2017
(86) PCT No.: PCT/IL2017/050847

§ 371 Date: Feb. 6, 2019

Related U.S. Application Data
(60) Provisional application No. 62/371,769, filed on Aug. 7, 2016.

(51) Int. Cl. G06F 1/16; H04M 1/04; H04M 1/02

(52) U.S. Cl. CPC G06F 1/1607; G06F 1/1626; H04M 1/026; H04M 1/04

(57) ABSTRACT

A back panel for a mobile phone having an operating system supported on an infrastructure having a front and a rear, and a front panel overlying the front of the infrastructure, wherein the back overlies the rear of the infrastructure, and has a chassis for securing to the rear of the infrastructure, and a transformable main member having a plurality of interlocking elongate, prismatic elements selectably locked in a side by side, coplanar formation thereby to extend across the rear of the infrastructure, the transformable main member being adapted for transformation into a selfie stick by extension of the plurality of interlocking elongate, prismatic elements in a direction transverse to the chassis and to the infrastructure, a first end of the selfie stick being supportively connected to the chassis and a second distal end being a free end, adapted to be held in the hand of a user thereby to facilitate support and operation of the mobile phone by the user.

### FIELD OF THE INVENTION

The present invention relates to mobile phones having photographic capability.

### BACKGROUND OF THE INVENTION

Selfie sticks are known to be incorporated with holders for smartphones. For example, US Patent Publication No. US 2015/0029352 entitled Collapsible Cell Phone Boom Arm is directed to an extendible boom arm which is attached to a cell phone casing. In this regard, reference is also made to the ExtendaPic iPhone 5/5s Case, shown at http://www.extendapic.com/.

Reference is also made to U.S. patent application Ser. No. 14/922,232, now U.S. Pat. No. 9,473,608, of which one of the present inventors is co-inventor, entitled “Integral Range Extender and Mechanical Protector System for a Handheld Digital Device.”

### SUMMARY OF THE INVENTION

In accordance with the description below, there is provided a back panel for a mobile phone, transformable into a selfie stick. The mobile phone has an operating system supported on an infrastructure having a front and a rear, and a front panel overlying the front of the infrastructure, and the back panel is configured to overlie the rear of the infrastructure.

In accordance with a further embodiment, there is provided a mobile phone incorporating the back panel as described herein.

Preferably, the back panel includes:

a chassis for securing to the rear of the infrastructure; and

a transformable main member having a plurality of interlocking elongate, prismatic elements selectably locked in a side by side, coplanar formation thereby to extend across the rear of the infrastructure, the transformable main member being adapted for transformation into a selfie stick by extension of the plurality of interlocking elongate, prismatic elements in a direction transverse to the chassis and to the infrastructure , wherein a first end of the selfie stick is supportively connected to the chassis and a second distal end is a free end, adapted to be held in the hand of a user thereby to facilitate support and operation of the mobile phone by the user.

In an additional embodiment, each of the plurality of interlocking elongate, prismatic elements is a linear element having a longitudinal axis, adapted for an axial sliding motion parallel to at least one other adjacent elongate, prismatic element, the axial sliding motion in a first direction being required so as to achieve the transformation of the transformable main member into a selfie stick, and further, in a second direction opposite to the first direction, so as to achieve retraction thereof into the coplanar formation.

In a further embodiment, the chassis includes a peripheral frame fastenable to the infrastructure of the mobile phone, for mounting the transformable main member onto the mobile phone.

In an additional embodiment, transformation of the transformable main member into a selfie stick is operative to at least partially expose the infrastructure of the mobile phone.

In a further embodiment, the chassis also includes a protective layer mounted within the frame and behind the transformable main member such that the infrastructure of the device is covered.

In an additional embodiment, the protective layer is at least partially retractable through the back panel so as to at least partially expose the infrastructure of the mobile phone while the back panel remains mounted thereon.

In a further embodiment, the transformable main member includes:

a first end prismatic element terminating in the first end for engaging the chassis;

a second end prismatic element terminating in the second end for being held in the hand of a user; and

a plurality of intermediate prismatic elements connected to the first and the second end elements.

In an additional embodiment, each of the prismatic elements is adjacent to and operative for interlocking engagement with and side by side sliding along at least one other of the interlocking elongate, prismatic elements.

In a further embodiment, wherein each intermediate prismatic element is adjacent to and operative for interlocking engagement with and side by side sliding along two of the plurality of interlocking elongate, prismatic elements.

In an additional embodiment, each prismatic element includes:

a track configured to face laterally towards an adjacent prismatic element in a first direction,

a link element formed on the opposite side of the prismatic element relative to the track so as to extend towards an adjacent prismatic element in a second direction, opposite to the first direction, wherein the link element of one prismatic element is adapted to engage the track of an adjacent prismatic element so as to be slidably movable therealong; and

a stop element provided at the end of the track so as to prevent disconnection of the link element from the track of the adjacent prismatic element.

In a further embodiment, the first end prismatic element is connected to the chassis via a hinge arrangement having at least two degrees of freedom so as to facilitate a desired angular adjustment of the transformable main member relative to the chassis and to the front panel of the mobile phone.

In an additional embodiment, there is also provided a remotely located control for operating the mobile phone.

### BRIEF DESCRIPTION OF THE DRAWINGS

The present invention will be more fully understood and appreciated from the following detailed description taken in conjunction with the drawings in which:

FIG. 1 is a schematic exploded view of a mobile phone constructed in accordance with the present invention;

FIG. 2 is a rear isometric view of a back panel of a mobile phone, constructed in accordance with a first embodiment;

FIG. 3A is a rear isometric view of a mobile phone including the back panel of FIG. 2, wherein the back panel is in a position prior to transformation of its transformable main member into a selfie stick;

FIG. 3B is a front isometric view of the mobile phone of FIG. 3A after transformation of the back panel main member into a selfie stick;

FIGS. 4A-4D show the mobile phone of FIGS. 3A and 3B, depicted from the rear, top, side and bottom, respectively;

FIG. 5 shows how the transformable main member fits together with the remainder of the phone after transformation of the main member into a selfie stick;

FIG. 6 shows an enlarged view of a portion of FIG. 5;

FIG. 7A is a view similar to FIG. 3B, but after full assembly of the transformed main member with the remainder of the phone;

FIG. 7B shows the mounting of a first end prismatic element of the transformable main member so as to support the remainder of the phone;

FIG. 7C shows an enlarged view of a portion of FIG. 7B;

FIG. 8A shows the connection between two prismatic elements of the transformed main member;

FIG. 8B is an enlarged view of the connection of FIG. 8A;

FIGS. 9A and 9B are block diagram illustrations of basic interactive operational components of the deployed selfie stick with the remainder of the mobile phone, wherein the mobile phone is operated via a wired connection and a wireless connection, respectively;

FIGS. 10A and 10B shows a back-panel inner layer or chassis as seen in FIGS. 7A and 7B, but having clips provided thereon for fastening the transformable main member thereto;

FIG. 11 is a schematic illustration of a second end prismatic element functioning as a selfie stick handle, housing therein a backup battery;

FIGS. 12A-12E are rear, front, left side, right side and bottom views of a mobile phone having a back panel constructed in accordance with an additional embodiment;

FIG. 13A is a partially exploded isometric rear view of the back panel of the mobile phone seen in FIGS. 12A-12E, the transformable main member thereof shown in an intermediate position of transformation to a selfie stick;

FIG. 13B is a yet further exploded view of that seen in FIG. 13A, wherein a first end elongated prismatic element of the transformable main member is depicted, detailing in exploded view a hinge arrangement by which the main member connects to the inner layer or chassis of the back panel;

FIG. 14A is a rear view of the back panel, following extension of most of the interlocking elongate, prismatic elements of the transformable main member;

FIG. 14B is a view similar to FIG. 14A, following complete extension of the interlocking elongate, prismatic elements of the transformable main member and transformation into a selfie stick;

FIG. 15 is a rear perspective view of the back panel, similar to FIG. 14B;

FIG. 16 is a cross-sectional side view of the back panel as seen in FIGS. 13A-15, following full deployment of the selfie stick;

FIGS. 17A and 17B are side and front views of the mobile phone of FIGS. 12A-12B following full transformation of the transformable main member of the back panel into a selfie stick;

FIG. 18 is a rear view of a back panel of a mobile phone, in which the phone infrastructure is seen to be exposed on transformation of the main member of the back panel into a selfie stick; and

FIG. 19 is a view similar to FIG. 18, but wherein the chassis of the back panel includes a removable protective layer separating the back panel transformable main member from the phone infrastructure.

### DETAILED DESCRIPTION

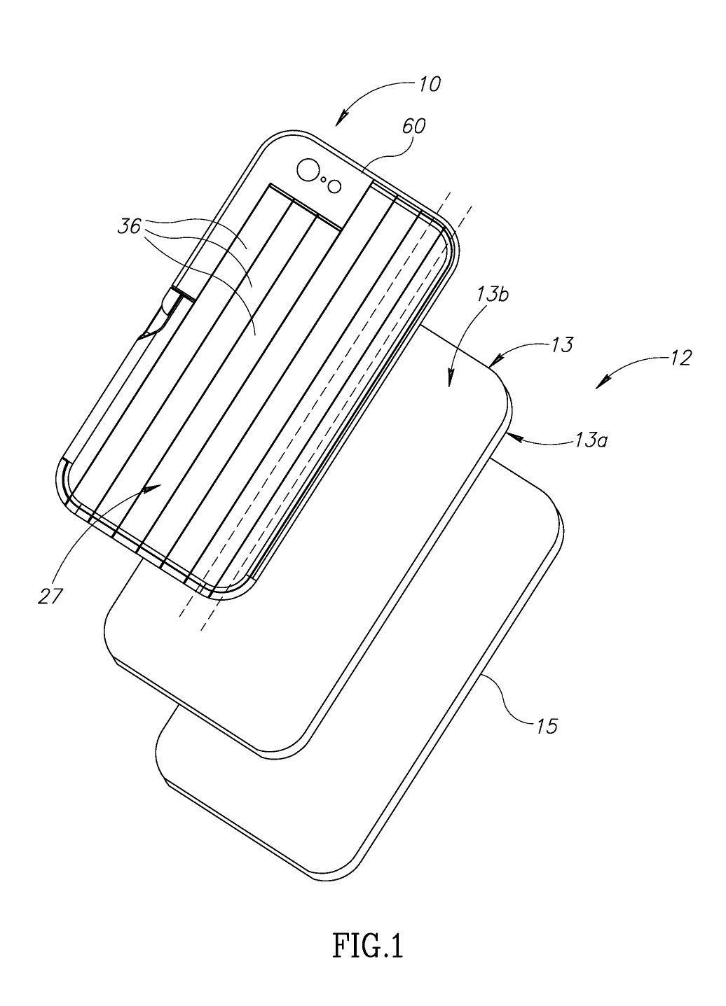

Reference is made initially to FIG. 1, which is a schematic exploded view of a mobile phone 12 constructed in accordance with an embodiment of the present description. Phone 12 has an infrastructure 13 with a frame or base for supporting the main interior operating components of the phone as known in the art; a front panel 15 overlying the front 13a of infrastructure 13; and a back panel 10 overlying the rear 13b of infrastructure 13. Front panel 15 includes the front display of the phone, as known in the art, and is not therefore specifically described herein.

The back panel 10 includes chassis 60 for securing to the rear 13b of the infrastructure 13, and a main member 27 transformable into a selfie stick, formed of a plurality of interlocking elongate, prismatic elements 36. Chassis 60 is secured to infrastructure 13b in any appropriate manner as known in the art, and is not detailed specifically herein. Elements 36 are locked in a side by side, planar arrangement, thereby to extend across the rear 13b of the infrastructure 13 of the mobile phone in a first operative mode.

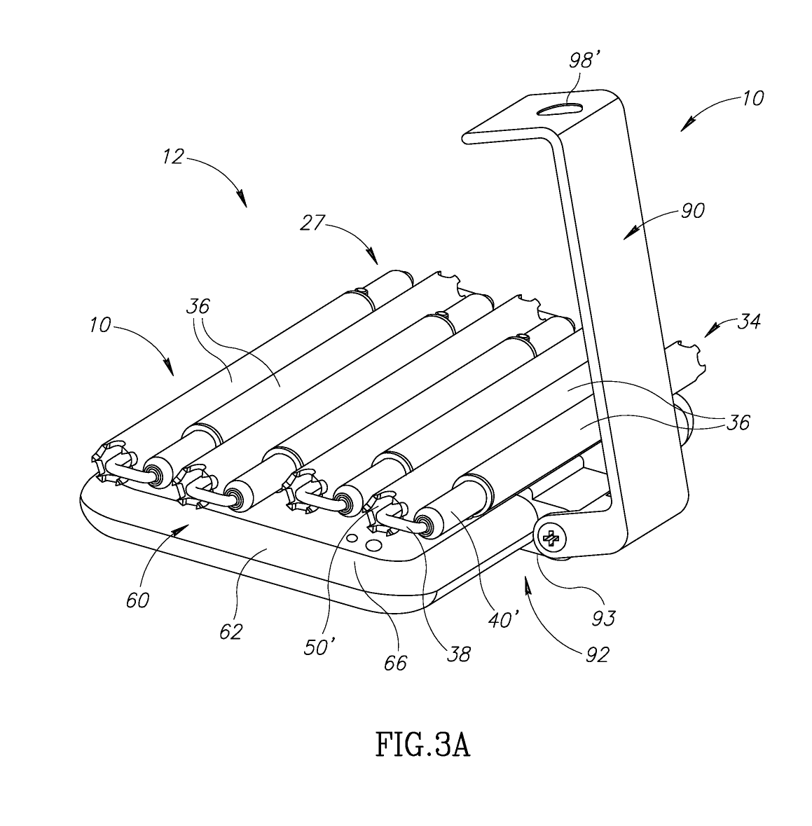

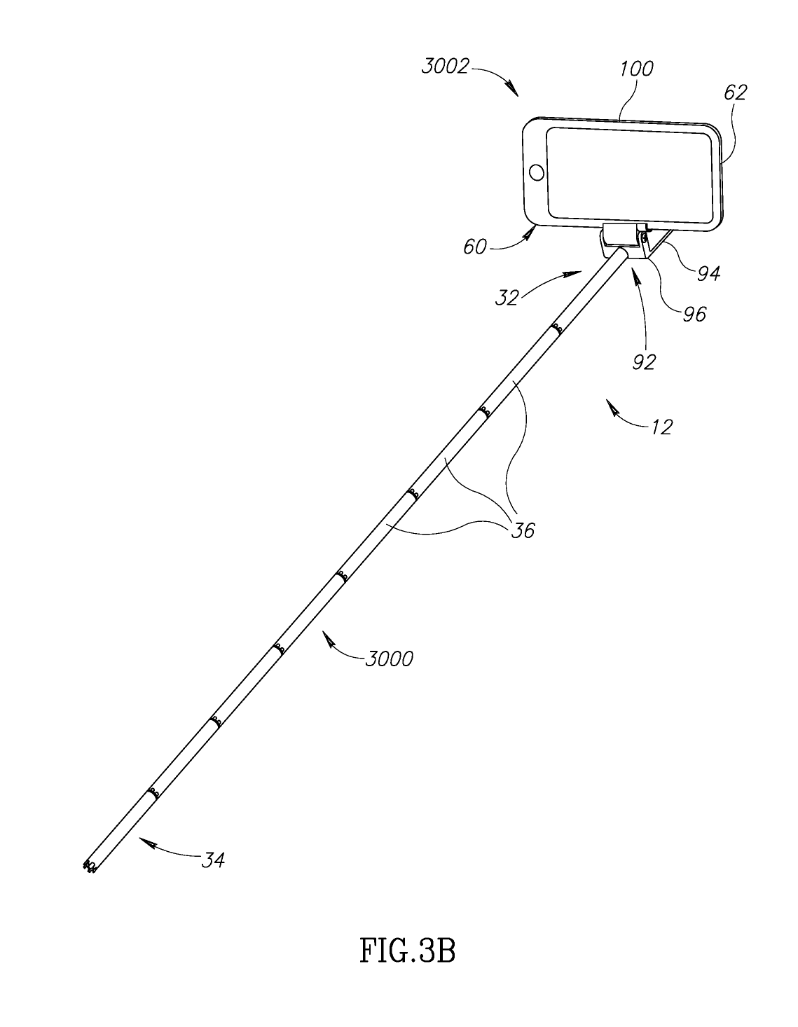

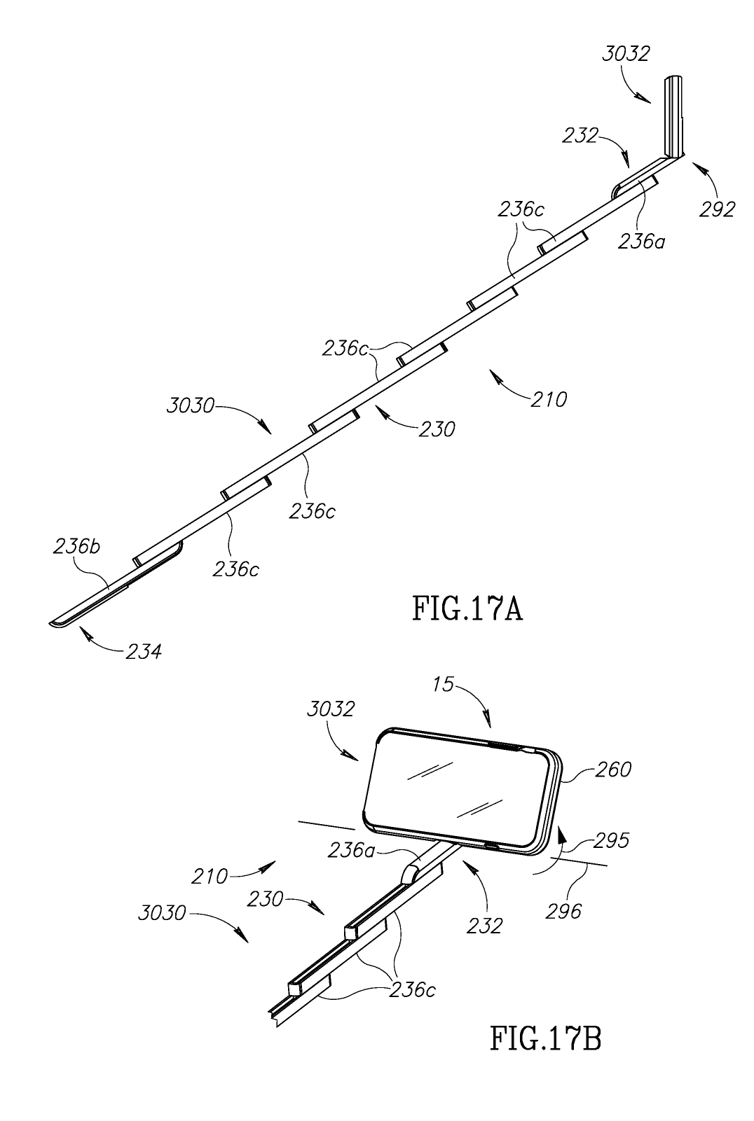

In view of the dual use of the transformable main member 27 of back panel 10, when used as a selfie stick, such as illustrated in FIGS. 3B and 17B, the two resulting portions of the mobile phone device are referenced, in the various embodiments shown and described hereinbelow, as selfie stick 3000 (for example, in FIG. 3B) or 3030 (for example, FIG. 17B), while the remainder of the device, namely, that portion of the device which is mounted on the selfie stick for use remotely from a user holding the free end thereof is referenced as main body 3002 (for example, FIG. 3B) or 3032 (for example, FIG. 17B).

Outer layer 27 may be transformed into a selfie stick, as shown and described hereinbelow, by extension of the plurality of prismatic elements 36 in a direction transversely away from the chassis 60 and infrastructure 13, wherein one end of the selfie stick is supportively connected to the chassis 60 while the other end is a free end, adapted to be held in the hand of a user thereby to facilitate support and operation of the main body 3002 or 3032 by the user.

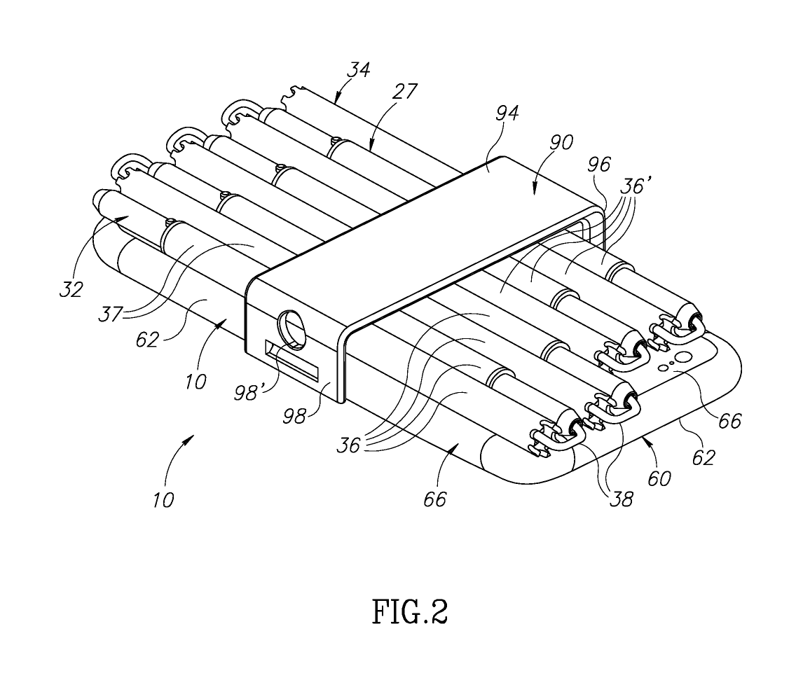

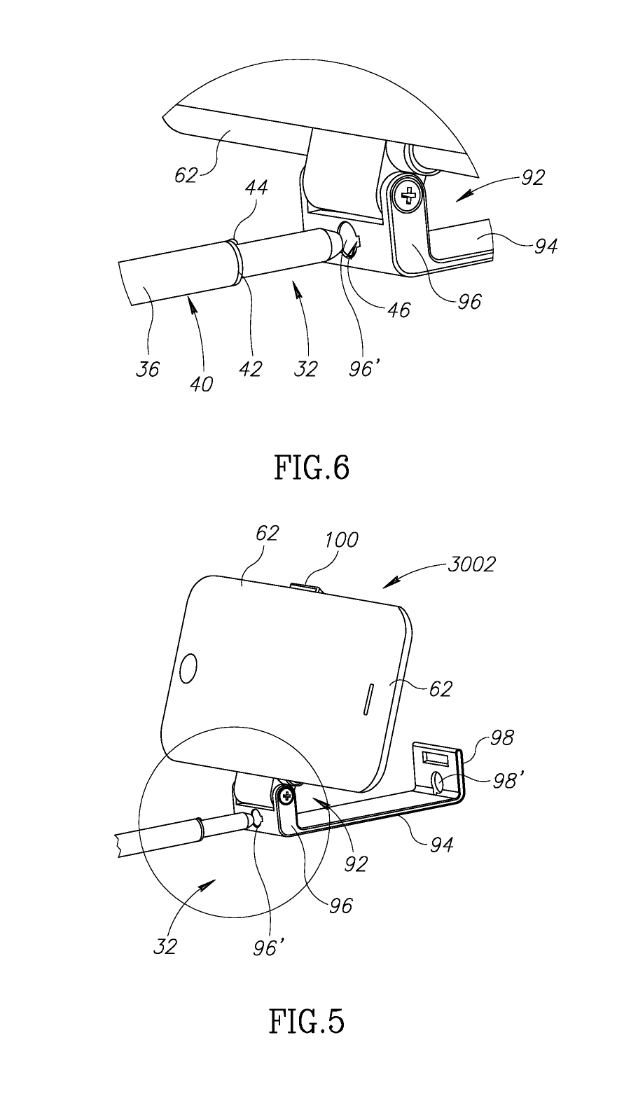

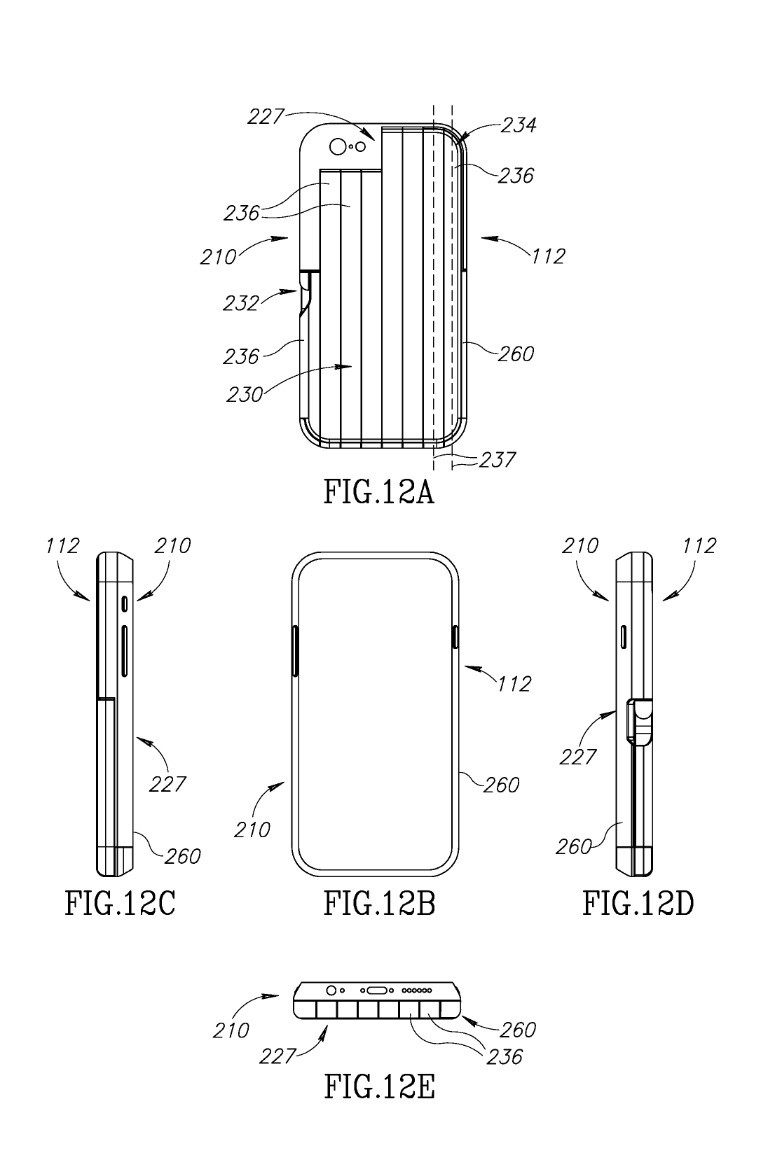

It will be appreciated that while back panel 10 is exemplified in FIG. 1 as the back panel shown and described in conjunction with the embodiment of FIGS. 12A-17B, back panel 10 may take other forms, for example, as shown and described in conjunction with FIGS. 2-10B.

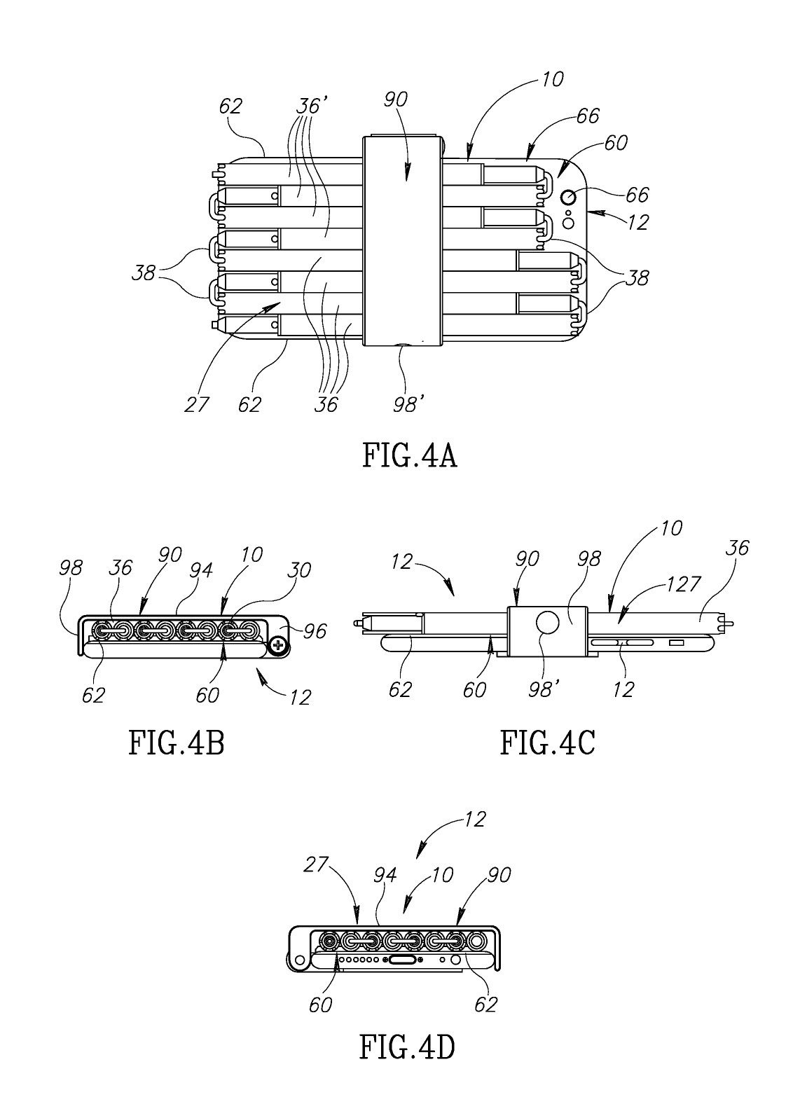

Referring now to FIGS. 2-4D, there is shown a mobile phone 12 (FIGS. 4A-4D), having a back panel 10 at least a portion of which is selectably transformable into a selfie stick, as described below. The mobile phone may alternatively be a digital camera and/or video device or an audio recording device, by way of non-limiting example.

The back panel 10 includes a chassis 60 for securing to the rear 13b of the infrastructure 13 (FIG. 1) of the mobile phone 12, and a transformable main member 27 transformable into a selfie stick, being formed of a plurality of interlocking elongate, prismatic elements 36. Elements 36 are selectably locked in a side by side, planar formation thereby to extend across the rear of the infrastructure of the mobile phone in a first operative mode.

Outer layer 27 is transformable, as mentioned, into selfie stick 3000 by extension of the plurality of prismatic elements 36 in a direction transverse to the chassis 60 and to the infrastructure 13 (FIG. 1), wherein a first end 32 of the selfie stick is supportively connected to the chassis 60 and a second distal end 34 is a free end, adapted to be held in the hand of a user thereby to facilitate support and operation of the main body 3002 (FIG. 3B) of the mobile phone 12 by the user.

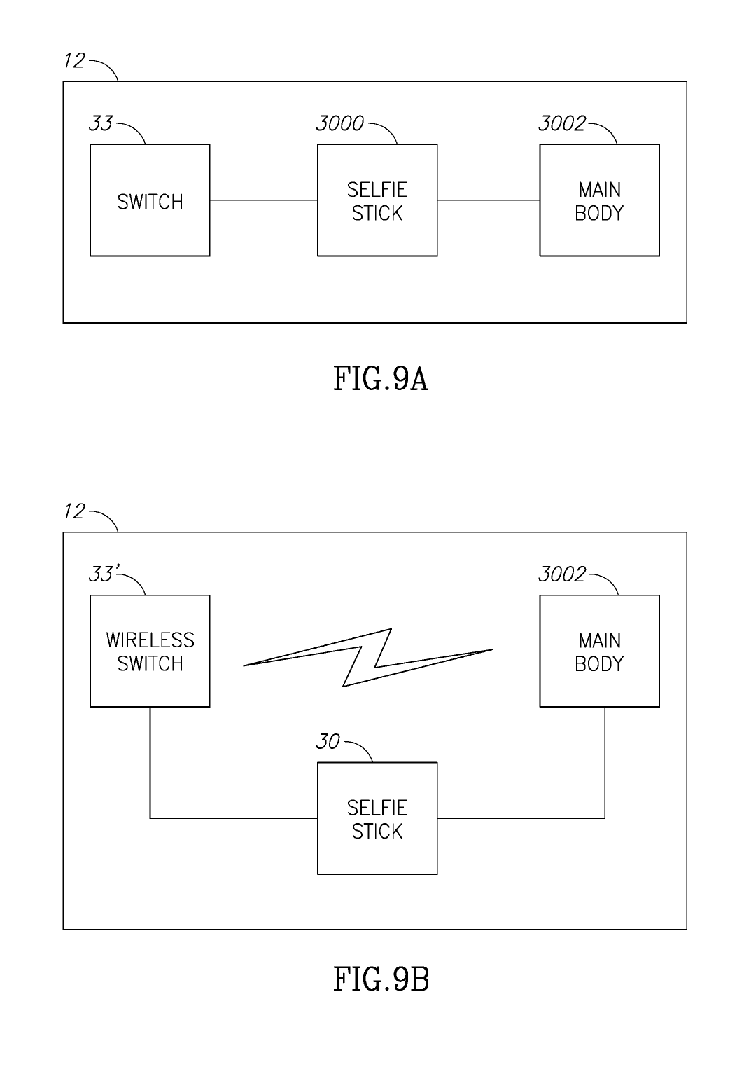

Referring now briefly to FIGS. 9A and 9B, when plurality 30 of interlocking elongate, prismatic elements 36 are extended and positioned as a selfie stick 3000, a suitable selector or switch 33 (FIG. 9A), connected to the device operating system via a suitable wired connection, or a wireless switch 33′ (FIG. 9B), such as a Bluetooth button or the like, is used to activate mobile phone 12. If switch 33 is a wired switch as depicted in FIG. 9A, then it may be located on the second end 34 of the selfie stick, substantially as known in the art. However, if switch 33′ is a wireless switch as depicted in FIG. 9B, it may be either be mounted on the second end 34 of selfie stick 3000 held by the user or be hand-carried separately.

In yet a further embodiment, the Bluetooth switch may be implemented as a Bluetooth function of a mobile device being carried by a user-authorized additional person in the vicinity of the user.

In the first mode of use the transformable main member 27 is engaged with the rear of chassis 60, being further secured by a dual-purpose engagement member 90. As described below, prismatic elements 36 are manufactured so as to be strong, while nonetheless taking up minimal space, having a small diameter. In its non-transformed state, transformable main member 27 cooperates with chassis 60 to cover the entire rear of the mobile phone 12, providing substantive mechanical protection thereto.

In the present embodiment, prismatic elements 36 are formed so as to be small and lightweight so as have minimal bulk, strong so as to enable minimal size and maximum length, and easily deployable as a selfie stick. To this end, elements 36 may be formed to have a thin diameter, for example, of about 8mm. Further, elements 36 may be produced by a 3-D printing process and formed of PLA and/or ABS mixed with a multi-directional carbon fiber. In accordance with one embodiment, when back panel 10 is for use with a mobile phone 12 such as a Samsung Galaxy S6® or an iPhone 6®, the length of the fully extended selfie stick 3000 may be 80 cm or more.

In an embodiment of the description, a strong elastic cord 38 runs through the interior of the prismatic elements 36 so as permit compact, folded storage. After the engagement member 90 is opened and the prismatic elements 36 are extended, the presence of the elastic cord imposes a tensile force along the entire combined length of the elements 36, so as to bring them into alignment and axially pull them together into end-to-end mating connection with each other, such that the elements 36 become fully deployed.

Mobile phones have various features including operating switches, view finders, earphone jacks, power ports and the like. For example, a camera lens 66 may be mounted in chassis 60 of back panel 10 and rod elements 36 thereof are formed of specific sizes so as not obscure lens 66, or indeed, any other feature that may be built in to back panel 10. Thus, as seen in FIGS. 2 and 4A, in the present example, prismatic elements 36′ are shorter than the remaining prismatic elements 36.

The chassis 60 is formed such that's its perimeter edges 62 engage the internal infrastructure of the device and may abut its front panel 15 (FIG. 1). Typically, the manner in which back panel 10 engages and abuts infrastructure 13 may be of any suitable manner known in the art, and is thus not detailed herein.

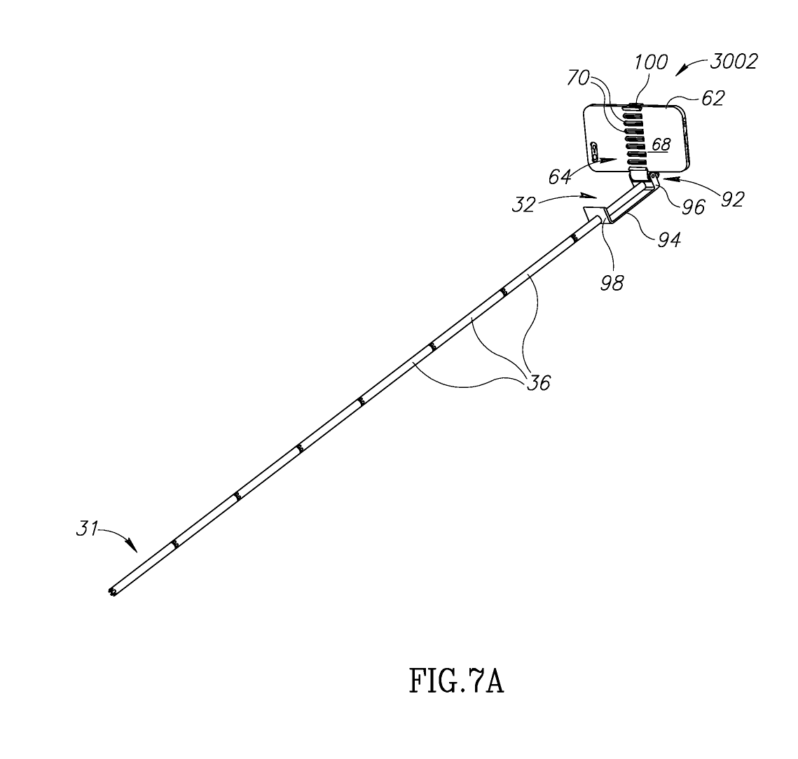

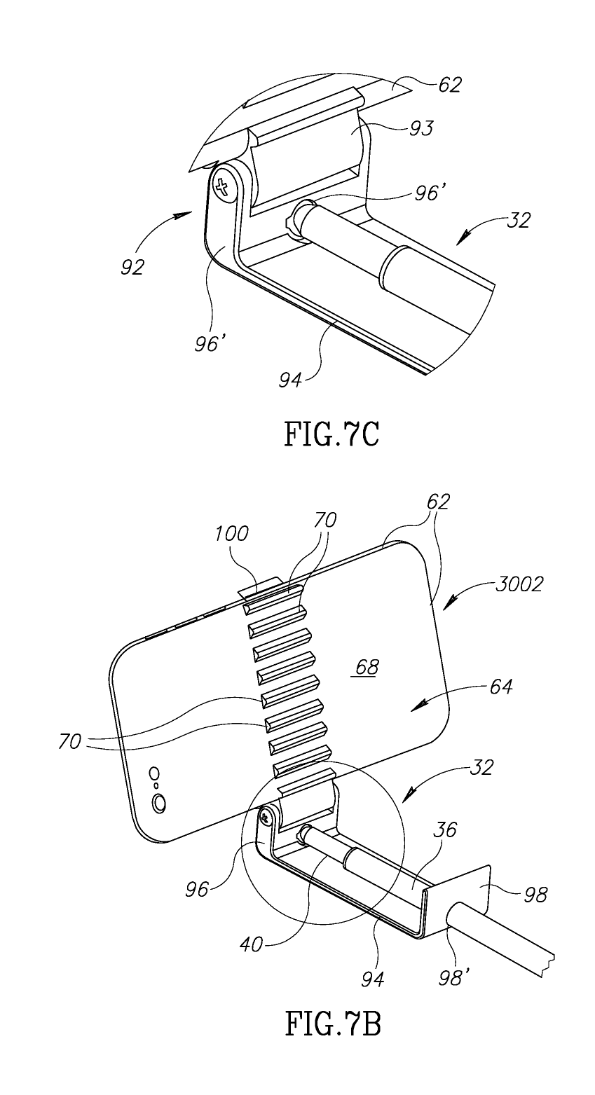

As seen particularly in FIGS. 7A and 7B, a rear-facing side 68 of chassis 60 is especially configured so as to engage prismatic elements 36 of transformable main member 27. According to one embodiment, there are provided positioning elements 70, illustrated herein as ridges, operative to receive the prismatic elements 36 in their first mode of operation.

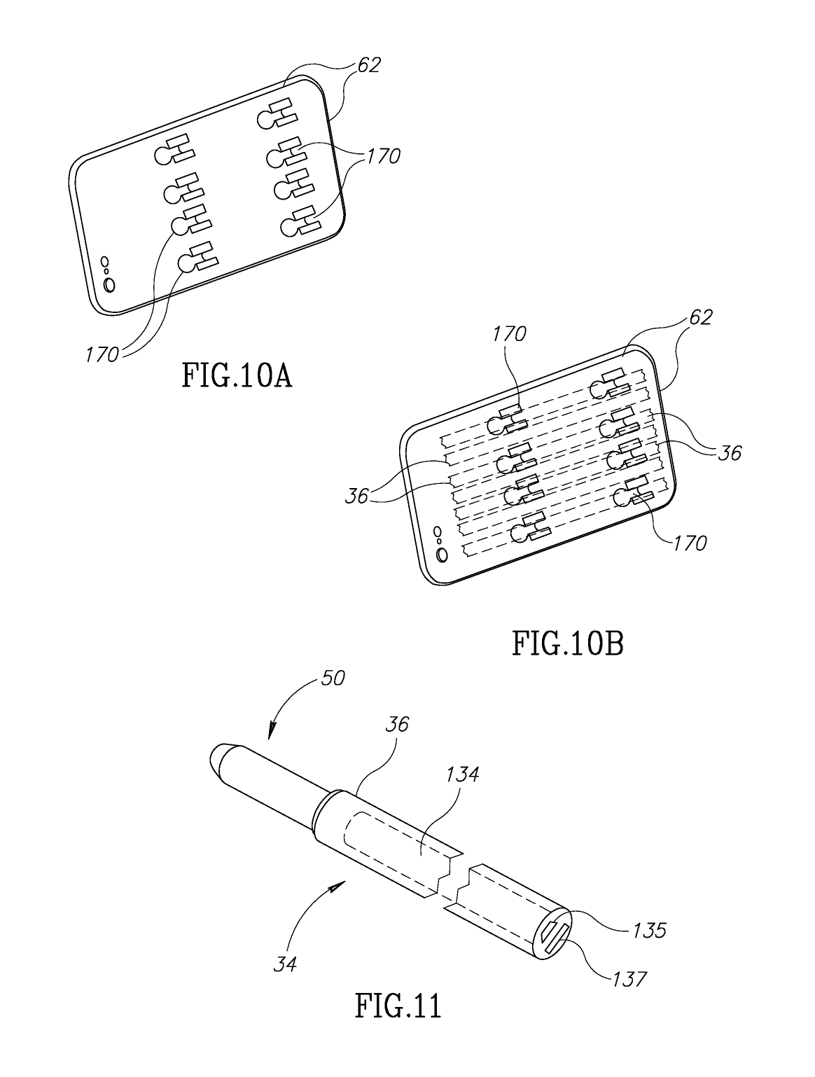

Referring briefly to FIGS. 10A and 10B, there may be provided fastening elements 170 as clips or the like so as to actively grasp the prismatic elements 36 therebetween so as to fasten them to the rear-facing side of chassis 60. It will be appreciated that the schematically illustrated clips 170 represent merely one possible way of fastening the prismatic elements 36 to the rear of the chassis 60, and is intended to include any equivalent manner of doing the same.

Dual purpose engagement member 90 is connected to chassis 60 by a suitable hinge construction 92. In the illustrated embodiment engagement member 90 has a generally elongated U-shaped clasp configuration, having a central portion 94 which is approximately equal to the width of back panel 10, and first and second end portions, respectively referenced 96 and 98. The engagement member 90 is formed so as to retain the folded prismatic elements 30 against the rear side 68 of the chassis 60, when retracted and in use as transformable main member 27.

Each of the shorter end portions 96 and 98 has a specific task. First end portion 96 is not only connected by hinge 92 to a suitable flange portion 93 (FIG. 7C) formed on the side of the chassis 60, but it also has formed therein a first shaped opening 96′. Second end portion 98 is a free end, operative in securing the elongated prismatic elements 36 against the rear panel 68 of chassis 60, as engagement member 90 is closed about hinge 92 and second end portion 98 is locked against a fastener element 100 formed integrally with chassis 60. As the engagement member 90 and chassis 60 are formed from high strength materials with a certain amount of elasticity, engagement member 90 is opened merely by grasping the free edge of second end portion 98 and flexing out outward and over the fastening element 100. Alternatively, any other suitable method of locking engagement member 90 about the elongated prismatic elements 36 may be employed.

First shaped opening 96′ is formed so as to engage with a free end portion of the selfie stick 3000, and, as illustrated in FIGS. 3B-6, so as to support main body 3002. The free end portion of selfie stick 3000 terminates in a male locking member 40 adapted for insertion through first shaped opening 96′ as seen in FIG. 6. The radius of male locking member 40 is smaller than that of the main body of prismatic element 36, thereby forming a limiting shoulder, seen at 42. As seen, the respective diameters of both the first shaped opening 96′ and male locking member 40 are approximately equal, thereby to permit locking member 40 to pass smoothly through the opening 96′ until limiting shoulder 42 abuts the edge opening 96′.

It is however necessary to prevent rotation of the main body 3002 of mobile phone 12 about selfie stick 3000 when in use. Accordingly, locking member 40 (FIG. 6) typically has formed thereon a radially oriented locking protrusion 44 immediately adjacent the limiting shoulder 42, adapted for insertion into locking engagement with a corresponding notch 46 formed adjacent to and communicating with shaped opening 96′. It will be appreciated that when protrusion 44 is engaged with notch 46, engagement member 90 and therefore chassis 60 and main body 3002 are prevented from rotating about selfie stick 3000.

In accordance with a preferred embodiment, first end portion 96 of the engagement member 90 supports the device merely by engagement of selfie stick 3000 in first shaped opening 96′.

In an alternative embodiment, there may be provided a second shaped opening 98′ in second end portion 98 of engagement member 90, wherein second shaped opening 98′ is coaxially aligned with opening 96′, but has a diameter which is approximately equal to that of rod element 36. When the main body 3002 of mobile phone 12 is mounted onto selfie stick 3000 in this manner, as illustrated in FIGS. 7A-7C, prismatic element 36 passes completely through second opening 98′ so as to extend across the gap between the second and first end portions of engagement member 90 and parallel to central portion 94. As seen, in this embodiment, male locking member 40 is also inserted through and locked with first shaped opening 96′ in a manner similar to that shown and described above in conjunction with FIGS. 3B-6, but from the interior of the clasp shaped engagement member 90. In this manner, selfie stick 3000 is operative to support chassis 60 and thus the main body 3002 at two locations, thus providing even greater stability, and thus also enabling the first engagement portion 96 to be made somewhat less thick.

As discussed above, it is desirable that once the prismatic elements 36 are assembled, they too are locked in a position whereat no relative rotation with respect to their longitudinal axis is permitted.

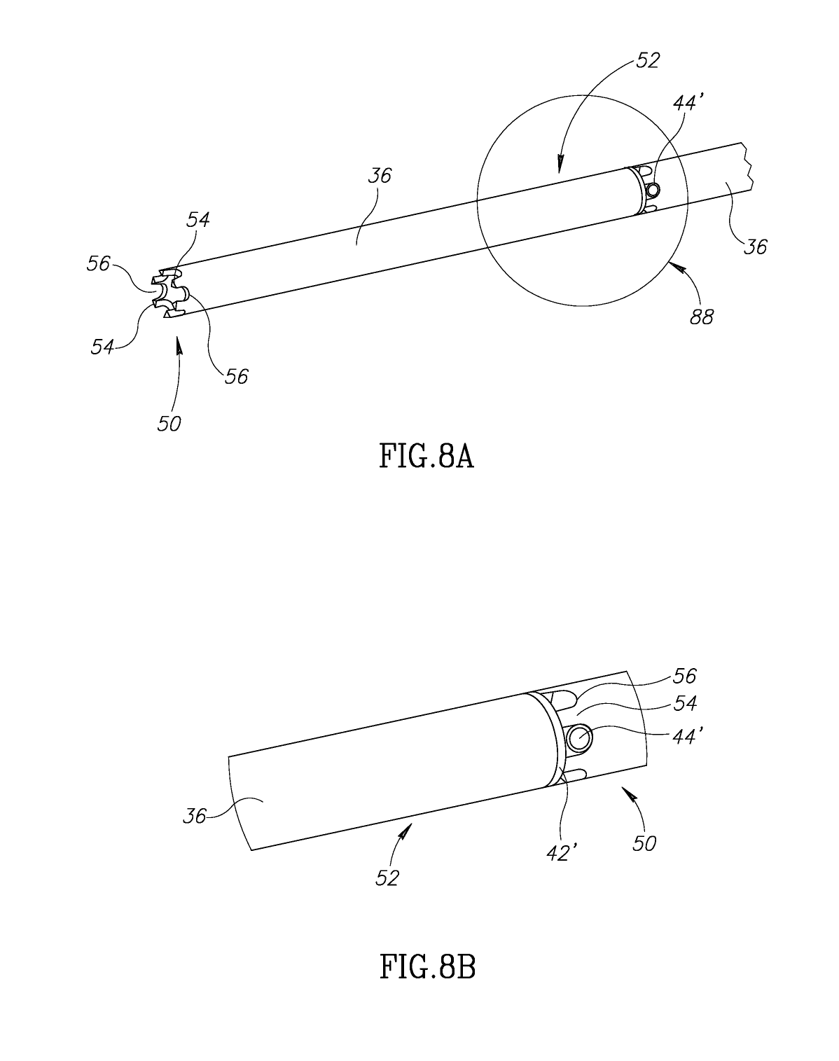

Referring now to FIGS. 8A and 8B, in order to prevent such undesired rotation from occurring, prismatic elements 36 are formed so as to interlock once they are fully locked with each other. Each prismatic element 36, in the present embodiment, is provided with different first and second ends, respectively referenced 50 and 52.

First end 50 has formed thereat a series of crenations, or an alternating sequence of teeth 54 and notches 56. The second end 52 of each prismatic element 36 is provided with a male locking member 40′ (FIG. 3A) which is similar to male locking member 40, shown and described above in conjunction with FIG. 6. Accordingly, locking member 40′ is smaller than that of the main body of prismatic element 36, thereby forming a limiting shoulder, seen at 42′. The respective diameters of both the end opening 50′ (FIG. 3A) of first end 50 and male locking member 40′ (FIG. 3A) are approximately equal, thereby to permit locking member 40′ to pass smoothly through the opening 50′ until limiting shoulder 42′ abuts teeth 54.

In order to prevent relative rotation between the two mutually engaged prismatic elements 36, however, locking member 40′ typically also has formed thereon a radially oriented locking protrusion 44′ immediately adjacent the limiting shoulder 42′, adapted for insertion into locking engagement with any of the notches 56. As described above, when transformable main member 27 is to be transformed into selfie stick 3000, the prismatic elements 36 are released and then straightened under the force of the elastic cord 38, and the adjacent first and second ends 50 and 52 of each pair of adjoining prismatic elements 36 are pulled together under the force of the cord 38. Therefore, all that is required so as to obtain full, non-rotational engagement of two adjoining prismatic elements 36, is that locking protrusion 44′ of male locking member 40′ engages any one of the notches 56 of the facing first end 50.

As described hereinabove, prismatic elements 36 are hollow, thereby being lightweight, and being suitable for a male-female interlocking mating when rod 30 is assembled and fully deployed. However, in accordance with one embodiment, and referring now to FIG. 11, the prismatic element 36 which functions as a handle when rod 30 is deployed, may serve to house a rechargeable backup battery 134, suitably configured so as to fit within the hollow interior of the rod element 36. Operating generally as known for such backup batteries, the exposed end of battery 134 typically has a micro-USB or other suitable type of port 135 so as to facilitate charging thereof, and a USB or equivalent-type port 137 for charging an electrical device such as mobile phone 12.

Referring now to FIGS. 12A-12E, there is shown a mobile phone 112 having a back panel 210 at least a portion of which is selectably convertible into a selfie stick, as described below. Back panel 210 is detailed herein, substantially only with regard to differences relative to back panel 10, shown and described hereinabove in conjunction with FIGS. 2-11.

Back panel 210 includes a chassis 260 adapted for securing to the rear of the infrastructure (not shown) of mobile phone 112 and a transformable main member 227. The back panel 210 includes a chassis 260 for securing to the rear of the infrastructure (not shown) of the mobile phone, and a transformable main member 227. Preferably, chassis 260 has a peripheral frame 261 which abuts the phone infrastructure in a manner which not merely mounts back panel firmly thereon, but also seals against the ingress of dirt and liquids.

Outer layer 227 is selectably convertible into a selfie stick, being formed of a plurality of interlocking elongate, prismatic elements 236. Elements 236 are selectably locked in a side by side, planar formation thereby to extend across the rear 13b (FIG. 1) of the infrastructure 13 of the mobile phone in a first operative mode.

In the following description, when transformable main member 227 is described in its transformed, extended or deployed state, it may be referred to as selfie stick 3030. Furthermore, the term ‘main body’ as used herein, means that portion of the phone which is mounted on the selfie stick 3030 for use remotely from a user holding the free end thereof.

In a second operative mode, the plurality 230 of interlocking elongate, prismatic elements 236 are extendable in a mutually supporting rod formation in a direction transverse to chassis 260 and to the infrastructure so as to be usable as selfie stick 3030. When deployed in this manner as a selfie stick, a first end 232 of the selfie stick 3030 is supportively connected to chassis 260 and a second distal end 234 is a free end, adapted to be held in the hand of a user thereby to facilitate support and operation of the main body 3032 of mobile phone 112.

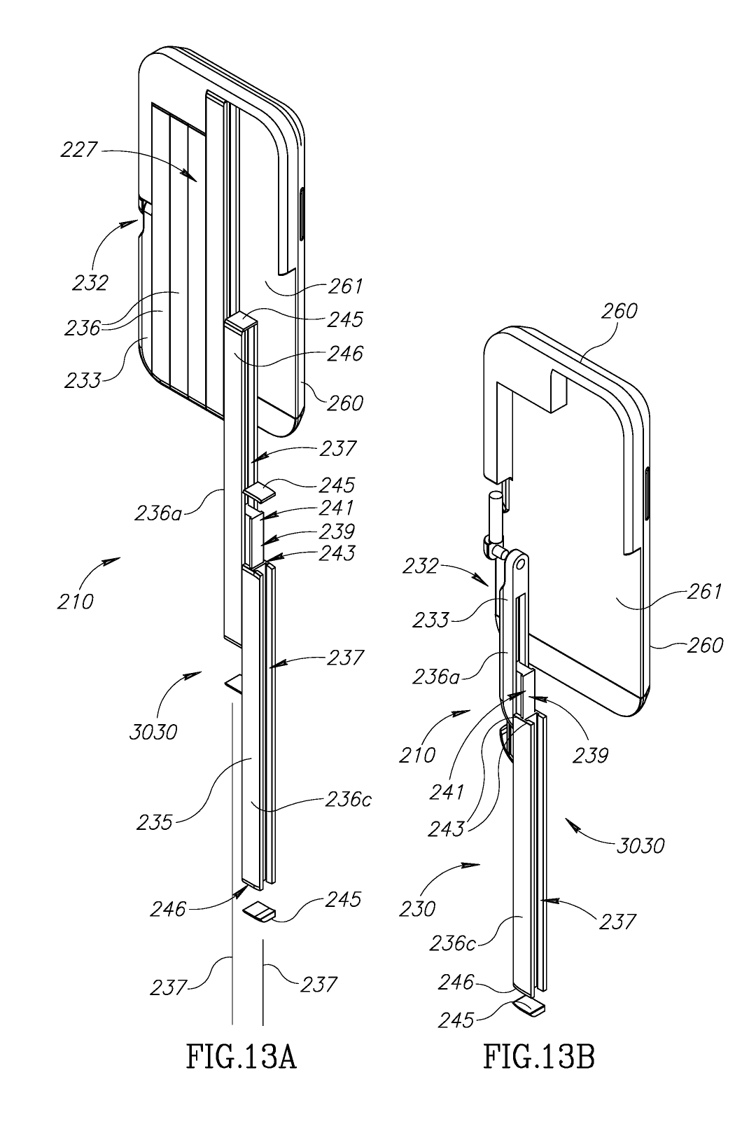

Referring now to FIGS. 13A and 13B, selfie stick 3030 extends in a direction transverse from the chassis 260, whereby a first end 232 of the selfie stick is adapted to support the main body 3032 of mobile phone 112 and a second distal end 234 is adapted to be held in the hand of a user. As depicted in FIG. 17A, in the second mode, extension of the selfie stick 3030 permits positioning of the main body 3032 of mobile phone 112 and use thereof, remotely from the user.

Transformable main member 227 includes a plurality 230 of parallel, interlocking elongate, prismatic elements 236 configured for side by side substantially overlapping, coplanar arrangement when in the first operative mode, as seen, inter alia, in FIG. 12A; and for side by side partially overlapping, coplanar arrangement functioning as selfie stick 3030 when in the second operative mode, as seen, inter alia, in FIG. 17A.

It is seen that each of the prismatic elements 236 is a linear element having a longitudinal axis 237 (FIGS. 12A and 13A), adapted for an axial sliding motion parallel to at least one other adjacent prismatic element 236. It will be appreciated that the axial sliding motion in a first direction causes extension of the plurality of prismatic elements 236 of which transformable main member 227 is composed, from a compacted arrangement overlaying the rear 13b of the infrastructure 13 of mobile phone 12 into an extended arrangement so as to become selfie stick 3030. Axially sliding the rod elements 236 in a second direction opposite to the first direction, causes retraction of the prismatic elements 236 and rearrangement into a compacted arrangement across the rear of infrastructure 13.

Referring now to FIGS. 13A and 13B, it is seen that among the plurality of prismatic elements 236 are a first end element 233 terminating in the first end 232 of selfie stick 3030, for engaging back panel chassis 260; a second end element 235 terminating in the second end 234 of selfie stick 3030, for being held in the hand of a user; and a plurality of interconnected intermediate elements 236, connected to the first and second end elements 233 and 235.

In the present example, each of the prismatic elements 233, 235 and 236 (reference numeral 236 being used to denote each of these types of prismatic element unless stated otherwise), is formed to include a track 237 which faces laterally outwards in a first direction, towards an adjacent prismatic element 236. There is further provided a link element 239 which is formed on the opposite side of the prismatic element 236 relative to the track so as to extend laterally towards an adjacent prismatic element 236 in a second direction, opposite to the first direction.

As seen, each of the prismatic elements 236 is in interlocking, side by side, sliding engagement with one or more prismatic elements 236 by engagement of link element 239 along an adjacent track 237. In the present example, this sliding interlocking arrangement is achieved by providing the link element 239 with a cross-sectional profile so as to be widened at its free end 241, the widened portion 241 being adapted for sliding within a correspondingly widened inner portion 243 of track 237, and effectively confined therewithin. There is also provided, however, a stop member 245 which is fastened to an end 246 of prismatic element 236 so as to prevent link element 239 from sliding out of an engaged track 237 during extension of selfie stick 3030 and consequent disconnection of the individual prismatic elements 236.

It will be appreciated by persons skilled in the art that the length of selfie stick 3030 when fully extended is a function of the length and number of prismatic elements 236, which in turn is a function of the strength of the elements 236 including their material strength. In one example, selfie stick 3030 is 71 cm in length, and its various components are made of various materials, including aluminum for tracks 237, plastic (nylon combined with glass fibers) for link elements 239, and plastic (ABS) for stop members 245. This is however merely one example, and other materials may also be used.

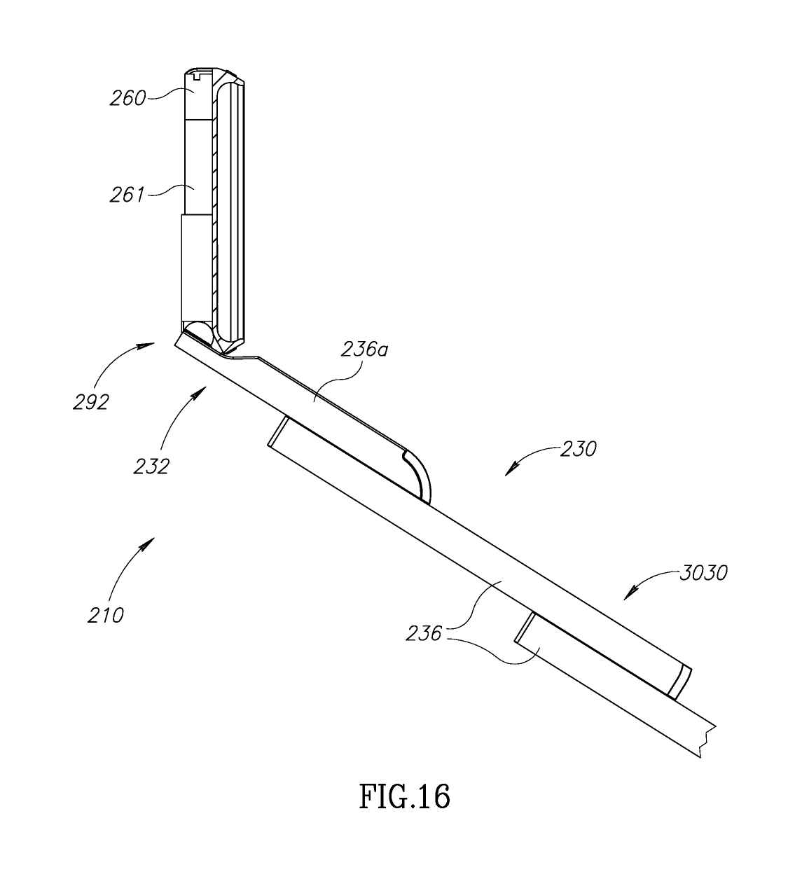

Referring now briefly to FIGS. 16, 17A and 17B, the first end element 236 of prismatic element 230 is connected to the chassis 260 via a hinge arrangement 292 having multiple degrees of freedom, which is adapted to permit a desired angular positioning of the chassis 260 and thus main body 3032 of mobile phone 112 with respect to selfie stick 3030, and typically in the illustrated, generally rearward position so as to face the user and thus permit a selfie photograph to be taken. It is however envisaged that other positions may also be desired, when seeking to use selfie stick 3030 in order to photograph a target from a different angle and/or closer range than the user would otherwise be able to achieve.

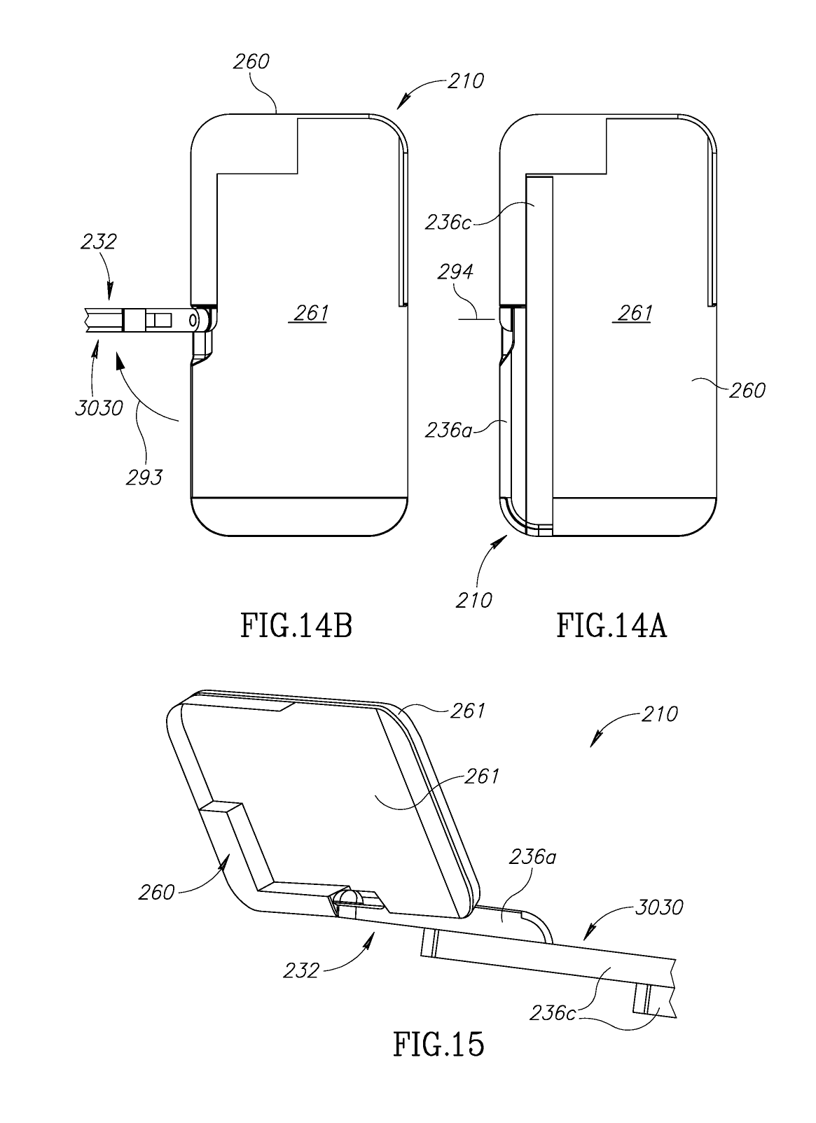

In accordance with one embodiment, hinge arrangement 292 may have a ball and socket type construction. The exploded view of FIG. 13B and the views of FIGS. 14A and 14B however illustrate a simple arrangement, having two degrees of freedom, in which there are seen a pair of mutually perpendicular joints enabling rotation of selfie stick 3030 about in a first direction illustrated by first arrow 293 (FIG. 14B) about a first axis 294 (FIG. 14A), and then, as seen in FIG. 17B, in a second direction, illustrated by second arrow 295, about a second axis 296, wherein the first and second axes are mutually perpendicular.

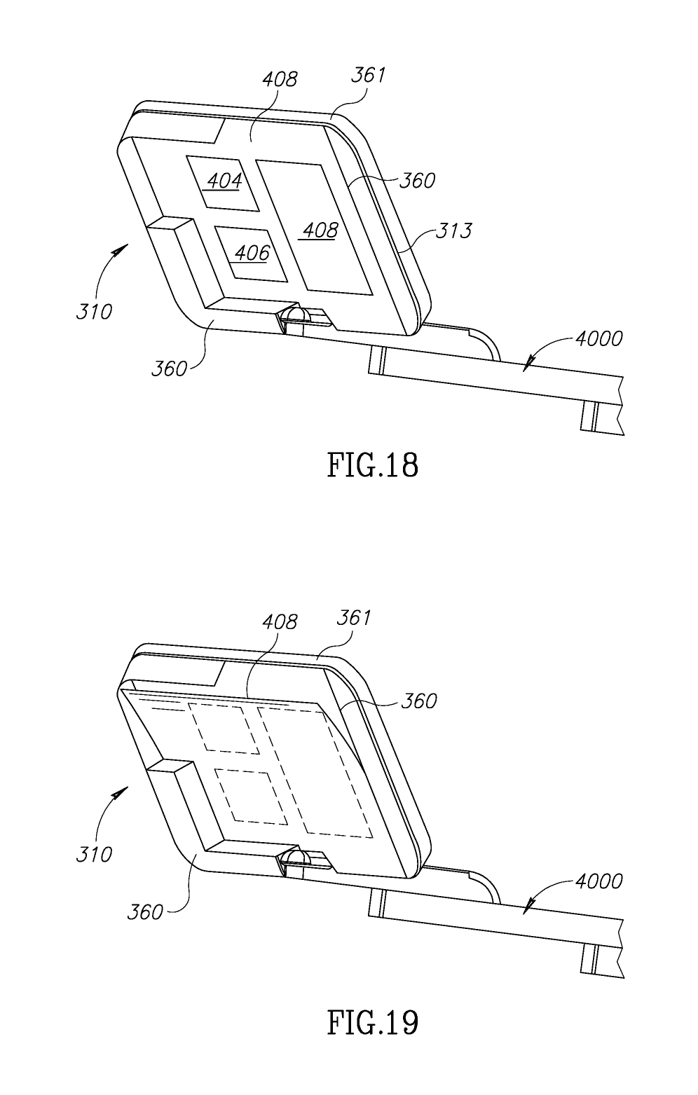

Referring now to FIG. 18, there is depicted from the rear, a back panel 310 of a mobile phone generally similar to that shown and described hereinabove in conjunction with FIGS. 12A-17B, and which is thus described herein only with regard to the difference therebetween. In the illustrated embodiment, chassis 360 consists primarily of a peripheral frame 361 by which back panel 310 fastens to infrastructure 313, in which some of the operating components of the phone are exposed. These may include, purely by way of example, a battery 402, SIM card 404 and a removable memory component 406. An advantage of this arrangement, is that convenient access to these components is provided merely by transforming the transformable main member into selfie stick 4000, rather than having to snap off back panel 310 which, at times, can be difficult to do.

FIG. 19 is a view of a device similar to that of FIG. 18, but also including a removable protective layer 408 which is fitted within peripheral frame 361, and which separates the back panel transformable main member from the phone infrastructure 313. In the illustrated embodiment, protective layer 408 is seen to be made of a flexible material which can be easily peeled back or otherwise removed through the back panel frame 361, without requiring prior removal of the back panel so to avoid exposure of phone operating components, while nonetheless permitting easy access thereto. Layer 408 may be formed of Mylar® film, although any alternative inner, removable layer may be provided

It will be appreciated by persons skilled in the art that the present invention is not limited by what has been shown and described hereinabove, merely by way of non-limiting example. Rather, the scope of the invention is defined solely by the claims, which follow.

1. For a mobile phone having an operating system supported on an infrastructure having a front and a rear, and a front panel overlying the front of the infrastructure,
a back panel for overlying the rear of the infrastructure,
said back panel including:
a chassis for securing to the rear of the infrastructure; and
a transformable main member having a plurality of interlocking elongate, prismatic elements selectably locked in a side by side, coplanar formation thereby to extend across the rear of the infrastructure, said transformable main member being adapted for transformation into a selfie stick by extension of said plurality of interlocking elongate, prismatic elements in a direction transverse to said chassis and to the infrastructure, wherein a first end of said selfie stick is supportively connected to said chassis and a second distal end is a free end, adapted to be held in the hand of a user thereby to facilitate support and operation of the mobile phone by the user.

2. A back panel according to claim 1, wherein each of said plurality of interlocking elongate, prismatic elements is a linear element having a longitudinal axis, adapted for an axial sliding motion parallel to at least one other adjacent elongate, prismatic element, said axial sliding motion in a first direction being required so as to achieve said transformation of said transformable main member into a selfie stick, and further, in a second direction opposite to said first direction, so as to achieve retraction thereof into said coplanar formation.

3. A back panel according to claim 2, wherein said chassis includes a peripheral frame fastenable to the infrastructure of the mobile phone, for mounting said transformable main member onto the mobile phone.

4. A back panel according to claim 3, wherein transformation of said transformable main member into a selfie stick is operative to at least partially expose the infrastructure of the mobile phone.

5. A back panel according to claim 3, wherein said chassis also includes a protective layer mounted within said frame and behind said transformable main member such that the infrastructure of the device is covered.

6. A back panel according to claim 5, wherein said protective layer is at least partially retractable through said back panel so as to at least partially expose the infrastructure of the mobile phone while said back panel remains mounted thereon.

7. A back panel according to claim 2, wherein said transformable main member includes:
a first end prismatic element terminating in said first end for engaging said chassis;
a second end prismatic element terminating in said second end for being held in the hand of a user; and
a plurality of intermediate prismatic elements connected to said first and said second end elements.

8. A back panel according to claim 7, wherein each of said prismatic elements is adjacent to and operative for interlocking engagement with and side by side sliding along at least one other of said interlocking elongate, prismatic elements.

9. A back panel according to claim 8, wherein each said intermediate prismatic element is adjacent to and operative for interlocking engagement with and side by side sliding along two of said plurality of interlocking elongate, prismatic elements.

10. A back panel according to claim 9, wherein each said prismatic element includes:
a track configured to face laterally towards an adjacent prismatic element in a first direction,
a link element formed on the opposite side of said prismatic element relative to said track so as to extend towards an adjacent prismatic element in a second direction, opposite to said first direction, wherein said link element of one prismatic element is adapted to engage said track of an adjacent prismatic element so as to be slidably movable therealong; and
a stop element provided at the end of said track so as to prevent disconnection of said link element from said track of said adjacent prismatic element.

11. A back panel according to claim 10, wherein said first end prismatic element is connected to said chassis via a hinge arrangement having at least two degrees of freedom so as to facilitate a desired angular adjustment of said transformable main member relative to said chassis and to the front panel of the mobile phone.

12. A back panel according to claim 1, also including a remotely located control for operating the mobile phone.

13. A mobile phone which includes:
an operating system supported on an infrastructure having a front and a rear,
a front panel overlying the front of the infrastructure, and
a back panel overlying the rear of the infrastructure, wherein said back panel is constructed and operative in accordance with claim 1.

14. A mobile phone which includes:
an operating system supported on an infrastructure having a front and a rear,
a front panel overlying the front of the infrastructure, and
a back panel overlying the rear of the infrastructure, wherein said back panel is constructed and operative in accordance with claim 3.

15. The mobile phone according to claim 14, wherein said chassis also includes a protective layer mounted within said frame and behind said transformable main member such that the infrastructure of the device is covered, and wherein said protective layer is at least partially retractable through said back panel so as to at least partially expose the infrastructure of the mobile phone while said back panel remains mounted thereon.
